(19) United States
(12) Patent Application Publication
(10) Pub. No.: US 2005/0160276 A1
(43) Pub. Date: Jul. 21, 2005

(54) System and method for a directory secured user account

(75) Inventors: Richard A. Braun, Mechanicsville, VA (US); Steven D. Radabaugh, Richmond, VA (US); Matthew L. Overstreet, Richmond, VA (US)

Correspondence Address: BAKER BOTTS L.L.P., 2001 ROSS AVENUE, SUITE 600, DALLAS, TX, 75201-2980, US

(73) Assignee: Capital One Financial Corporation

(21) Appl. No.: 10/759,960

(22) Filed: Jan. 16, 2004

(51) Int. Cl. H04K 1/00

(52) U.S. Cl. 713/185

(57) ABSTRACT

A system and method for providing network access includes identifying an available network resource, providing an access token to the available network resource, tracking the access token, and terminating the access token.

### TECHNICAL FIELD OF THE INVENTION

This invention relates generally to the field of network security, and more specifically, to a system and method for providing a directory secured user account.

### BACKGROUND OF THE INVENTION

Network security is a general term that refers to the ability of a network, or network administrator, to limit access to portions of a network based on the needs of the resources, and/or users of the systems coupled to the network. Generally, a network administrator provides network access to a user based on the function of that user within an organization, or within the structure of the network. For example, when the user is a human user, that user generally has a requirement to access portions of the network corresponding to the user's function within the company related to the amount of access to the network and the resources coupled thereto commensurate with that role. Network access is generally provided to the user by a security token, or password. When the user desires to access the network, the user enters his or her user identification, along with a password that validates that user. If the user requires greater access than is normally allocated to that user according to the user's access level, the user typically requests from the network administrator a greater level of access.

Many companies, institutions, agencies, and other organizations and individuals desiring to implement grid-based computing solutions for business functions are very limited in their ability to provide access to resources that may be utilized for grid-based computing. Often, a grid-based computing program may only be utilized for a resource that is coupled to a network and has an access level commensurate with the access level of the user to whom the resource is assigned. This form of access is extremely limiting for grid-based computing solutions, as well as other network-based computing tasks due to the inability of the system resource to access portions of the network where vital information may be stored.

### SUMMARY OF THE INVENTION

In accordance with embodiments of the present invention, disadvantages and problems associated with the previous techniques for providing network access may be reduced or eliminated.

According to one embodiment of the invention, a method for providing network access includes identifying an available network resource, providing an access token to the available network resource, tracking the status of the access token, and terminating the access token. Additional embodiments of this method may include providing the access token to the resource wherein the access token includes a user identification and a password for access to a portion of the network. Yet another embodiment includes providing a task to be performed by the available resource corresponding to the access token.

In another embodiment, a directory user secured account system includes an access token, an administrator, and a database. The access token is operable to provide access to at least a portion of the network, and the administrator identifies at least one available network resource to which the administrator can provide the access token.

The database is operable to store the status corresponding to the access token. In yet another embodiment, a system for providing a directory secured user account is provided that includes an access management module to generate at least one access token, a resource communication module to transmit the access token to an available resource, and a token management module to maintain the status of the access token and the resource.

An advantage of an embodiment of the invention includes providing access to available network resources without regard to the level of access assigned to the user of the resource. Yet another advantage is the ability of a network to maximize available resources to perform functions, while maintaining the security of the network. Yet another advantage is the ability to provide network access to resources that correspond to an application resident on the resource, while simultaneously allowing a second user the ability to access the resource for unrelated functions.

Certain embodiments of the invention may include none, some, or all of the above advantages. One or more other advantages may be readily apparent to one skilled in the art from the figures, descriptions, and claims included herein.

### BRIEF DESCRIPTION OF THE DRAWINGS

For a more complete understanding of the present invention and the advantages thereof, reference is now made to the following description taken in conjunction with the accompanying drawings:

FIG. 1 is a flowchart illustrating a method according to an embodiment of the present invention;

FIG. 2 is a network architecture in accordance with an embodiment of the present invention;

FIG. 3 is a network architecture in accordance with an embodiment of the present invention; and

FIG. 4 is a system for providing directory secured user accounts in accordance with an embodiment of the present invention.

### DETAILED DESCRIPTION OF THE INVENTION

As the use of computer networks has become more common, grid-based computing has emerged as a way for organizations, individuals, companies, agencies, and other groups to employ resources greater than those of an individual server or computer terminal to analyze large amounts of data. Additionally, improved computer processing speeds and memory capabilities allow for smaller percentages of a computer's processing capability to be utilized for any single task. In a grid-based computing scenario, a client with grid-based computing software may become idle. Upon becoming idle, the client or resource may notify an administrator that it is available to perform grid-based computing functions. The administrator may then send an amount of data to the resource for analysis. Upon completing the analysis, the client may return the results of the analysis to the administrator.

Organizations such as corporations, government agencies, non-profit organizations, and other public and private entities may use networks, such as a wide area network (WAN), a local area network (LAN), an Intranet, or other type of network to efficiently communicate between different locations and/or resources and clients. Often, individual users such as computer operators, staff, and employees may be assigned passwords, user identifications (users IDs), or other access identifiers that attribute a specific and pre-determined level of access to the user. Typically, a user may access any terminal within a network with few exceptions, in order to gain access to the portion of the network given to the user by his or her user identification and/or password. Additionally, individuals may use the Internet, or portions thereof, to communicate more effectively with other individuals or entities.

In accordance with the present invention, the term “resource” may be used to describe any server, personal computer, computer terminal, node, or any other device employing an input/output interface, a network interface, and a data processing unit. The term “network” may include a WAN, LAN, a metropolitan area network (MAN), portions of the Internet, or any other network, including an optical or wireless network, an intranet, or other network capable of transmitting data between resources.

Many of these entities may employ a file storage structure involving servers located at different locations within the network, coupled to the network, and able to communicate with each other via the network. Additionally, these system architectures may employ file storage systems that are geographically based according to the location of the servers. Accordingly, a user may be able to access the data storage system via a resource coupled to a server in the system architecture. Using this access, a user may input data that is subsequently stored in the server to which the client is coupled.

Large numbers of files may be stored in servers in the network that are searchable by resources coupled to servers in other geographic locations in the network using the system architecture. Due to the large number of files stored in such a network, searching for specific files or file types may be extremely difficult to perform by a single client. Additionally, performing computations using data located in different geographical locations requires significant bandwidth and may result in significant system degradation which may be disadvantageous to a system's network architecture. Moreover, searching for specific files or file types is extremely time-consuming and consumes a vast amount of network resources. For example, any user designed to find a specific file or file type may be required to search the entire network, routing through multiple servers in multiple geographic locations coupled to the network in order to search through what may be thousands, or even millions of files to find the desired file or file type.

Most resources that exist within a system's architecture have numerous applications resident thereon. These applications generally include computer programs that perform specific processing functions necessary for efficient operation of the organization employing the network, or the individual user when the resource is a personal computer terminal. Often, a user will employ one or more resources while accessing the computer with that user's assigned access level.

As processor speeds and memory availability increase for computer terminals and personal computers, in addition to network servers, all of which may be resources in a given system architecture, the amount of processing capability utilized by any given resource within a system architecture becomes a smaller percentage of the processing capability of the resource as a whole. As a result, many applications, and a large portion of processing capability of any given resource, may go unused at any given time. Accordingly, an available resource may include not only a resource that is idle within a system architecture, but also a resource that is being used by an individual or other resource. Additionally, an available resource preferably has sufficient processing capability to perform other functions which may assist in the effective implementation of a system architecture without impairing the user's ability to access the system.

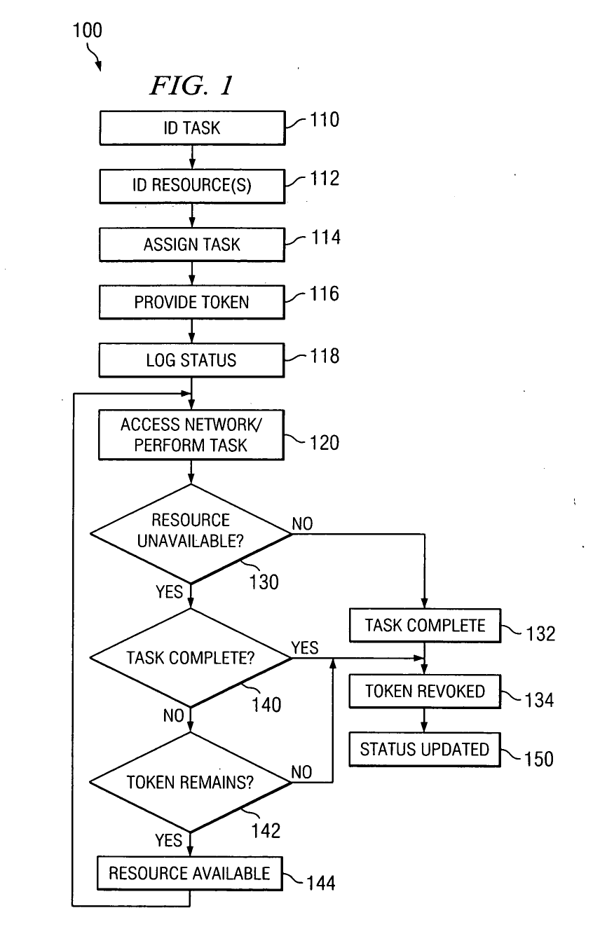

FIG. 1 illustrates a method 100 for providing network access to an available resource. At step 110, a task to be performed by an available resource is identified. At step 112 an available resource is identified. The available resource may be a computer terminal, a server coupled to the network, a personal computer coupled to the Internet, or any other hardware system coupled to the network having available processing capability. At step 114 a task is preferably assigned to the available resource. In a preferred embodiment, the task provided at step 114 corresponds to an application resident on the available resource. For example, if a user is accessing a resource's word processing application, other applications, such as a spreadsheet application, a database application, a search application, or other application may be unused while resident in the resource's memory. Accordingly, an administrator may provide a task assignment to the available resource corresponding to an application of the resource. At step 116, an access token is preferably provided to the resource. The access token may be a time-limited access token, a task-limited access token, or an open-ended access token to be ended at discretion of the administrator. Preferably, the access token is directed to the individual resource, and for the application on that resource to allow access to a pre-determined portion of the network. The pre-determined portion of the network may be any portion of the network containing data, or functions of the network necessary to perform the task provided at step 114. Alternatively, the token provided at step 116 may be a general access token, where the general access token provides access to the idle resource for a specified period of time or until the completion of a specified event.

At step 118, the status of the access token is preferably logged along with the status of the task provided to the resource. The status may be stored in a database dedicated to the administrator, or in any other suitable data storage device. Preferably, the access token is stored by a unique identifier that corresponds to the access token, the task provided to the resource, and/or the location of the resource. The location of the resource is preferably recorded as an Internet Protocol (IP) address, but may be any other suitable location identifier for the resource.

At step 120, the resource preferably accesses the portion of the network to which the resource was granted access through the access token, and begins to perform the task. At step 130, the resource may become unavailable. The resource may become unavailable due to a dedicated user for the resource accessing the application that is performing the task utilizing the access token. Alternatively, the user may turn the resource off, such as in the case of a personal computer or a computer terminal that has the power shut off at the end of a work day or at the end of an assignment by the user.

The resource may also become unavailable at step 130 if the user accesses an additional portion of processing capacity that exceeds a minimum allowable amount of processing capacity necessary for the task provided to the resource at step 114. If the resource remains available at step 130, at step 132 the task is preferably completed. The token may be revoked at step 134, and the status is updated at step 150. If, at step 130, the resource becomes unavailable, at step 140 the administrator determines whether the task provided at step 114 is complete. If the task is complete, at step 134 the token is revoked and at step 150 the status is updated. If the task is not complete at step 140, the administrator may allow the token to remain in effect at step 142, thereby waiting until the resource becomes available at step 144 to resume the task. If the token remains available at step 142 and the resource becomes available, the process resumes at step 120 where the resource accesses the network and performs the assigned task.

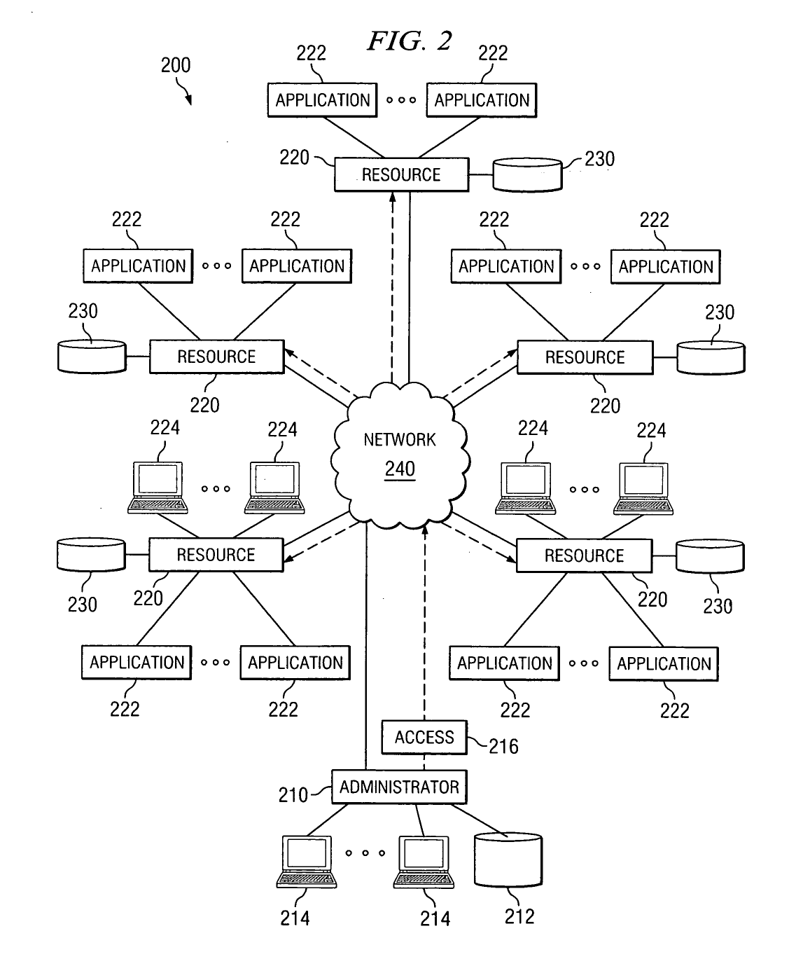

FIG. 2 illustrates system architecture 200 in accordance with a directory secured user account system. System 200 preferably includes an administrator 210, which has a dedicated storage 212 and input/output devices 214. Dedicated storage 212 may be a database, resident memory in administrator 210, or other suitable data storage device coupled to administrator 210. Input/output devices 214 may be computer terminals, keyboards, or any other device suitable for inputting data into administrator 210 for processing. Administrator 210 may be a computer terminal, personal computer, server, server group, or any other processing device coupled to network 240 and capable of transmitting data via network 240.

In addition to administrator 210, a plurality of resources 220 may be coupled to network 240. Resources 220 may have one or more input/output devices 224 coupled thereto, in addition to a data storage 230. Additionally, each resource 220 preferably has at least one application 222 resident within the memory, or processing capability of resource 220. For example, resource 220 may be a server running a single application for processing data for the purpose of communicating via network 240. Alternatively, resource 220 may be an individual computer terminal or personal computer with multiple applications 222 resident thereon to provide a plurality of functions associated with the resource.

Data storage unit 230 may be a dedicated storage device such as a database, or may be an internal memory storage, which may include one more suitable memory devices, such as one or more random access memories (RAMs), read-only memories (ROMs), dynamic random access memories (DRAMs), fast cycle RAMs (FCRAMs), static RAMs (SRAMs), field-programmable gate arrays (FPGAs), erasable programmable read-only memories (EPROMs), electronically erasable programmable read-only memories (EEPROMs), microcontrollers, or microprocessors.

Administrator 210 preferably directs an access token 216 to an available resource 220. Access token 216 may be any type of access gateway for access to other resources 220 or data storage units 230 coupled to network 240. For example, administrator 210 may receive a notification that a resource 220 has available processing capability associated with one or more applications 222 resident in the memory of a resource 220. Based on the notification, the administrator preferably directs an access token 216 to the available resource 220, thus allowing the application resident in the memory of the available resource 220 to begin operating at an access level that is separate from the access level normally associated with the available resource 220, or from the access level normally associated with a user of the available resource 220.

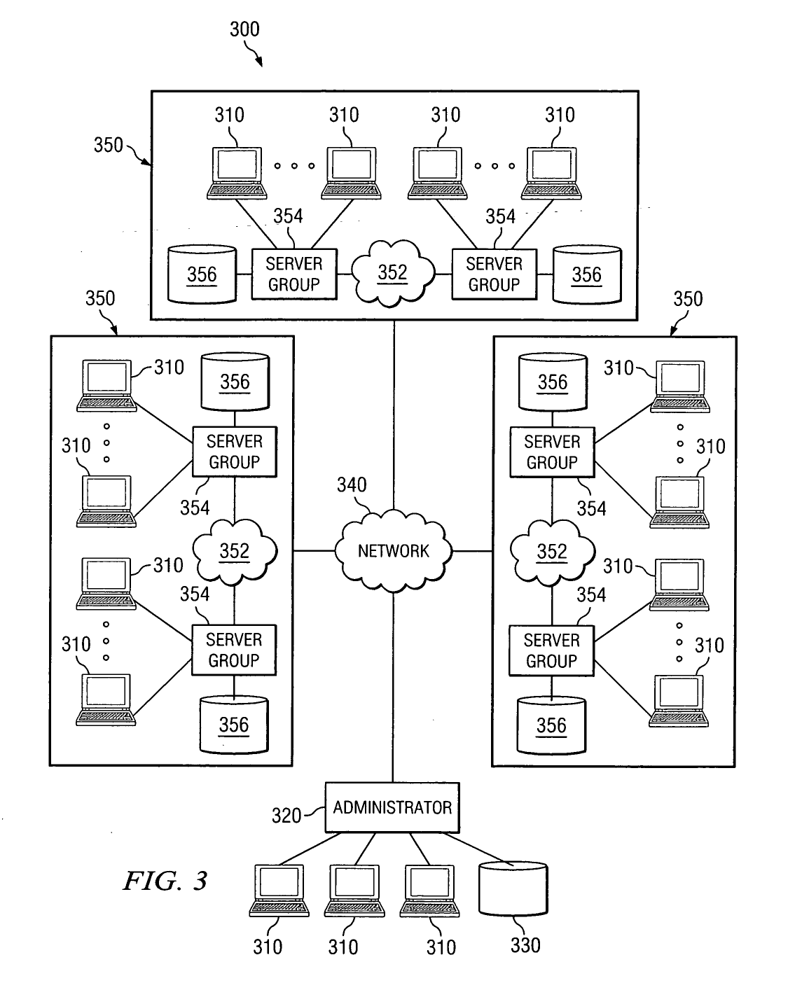

FIG. 3 illustrates a system 300, in which embodiments of the present invention may be performed. The architecture of system 300 is provided by way of example only. Thus, it should be understood that different embodiments of the present invention may be performed in different architectures based on the subject matter of the invention as defined by the claims. A system 300 includes multiple clients 310 coupled to server groups 354. Additionally, clients 310 may be coupled to administrator 320. Clients 310 may be user terminals, individual servers, or any other device capable of processing information, or performing a search for files or folders in a network. Administrator 320 may be a server, computer terminal, or other device coupled to network 340, and is preferably operable to provide secure access to files, folders, or any combination thereof, over network 340.

Super-groups 350 may include clients 310, server groups 354 coupled to each other by a sub network 352, and data storage units 356 coupled to server groups 354. Individual clients 310 are coupled to server groups 354 within a geographical region that is closer in proximity to another server group 354 within super-group 350 than to server groups in other super-groups 350. For example, a campus of a typical corporation may have several server groups, or sub-groups, located on the campus. The campus may be geographically separate from other campuses within the network architecture of the organization. Thus, in a particular embodiment, a super-group 350 may contain two buildings of a campus, each building housing a server sub-group 354 connected through a sub-network 352 to another building housing a server group 354 with clients 310 coupled thereto. Each super-group 350 is preferably coupled via network 340 to administrator 320. Additionally, a data storage device 330 is preferably coupled to administrator 320.

According to an embodiment of the invention, and in accordance with FIG. 3, the administrator 320 is preferably operable to administer or manage access to network 340, as well as access to network resources, such as super-groups 350, sub-networks 352, sub-groups 354, clients 310 and data storage units 356. This administration may include generating parameters for specific tasks, assigning access tokens to individual clients, and directing the database to store task information and/or access data. Once an access token has been generated by administrator 320, administrator 320 preferably directs the access token to an available resource or resources, such as servers located in super-groups 350, servers located in server groups 354, or to individual clients or servers within the network.

In a particular embodiment, any available resource may be operable to perform the a task or search required by the system, and thus be able to receive an access token generated by administrator 320. However, it may be desirable to limit network access to a specific server super-group 350, or server sub-group 354, in order to reduce traffic over network 340, so that a resource located in a specific server super-group 350 or sub-group 354 will search only within that super-group or sub-group, respectively.

In a particular embodiment, administrator 320 may not transmit an access token or any task criteria to the available resource until a client has notified administrator 320 that it is available to perform the search. This arrangement may be preferable in order to further reduce network traffic so that less information is sent to individual resources by administrator 320. Additionally, administrator 320 may direct database 330 to store all access token information, including task criteria, search parameters, and/or unique identifiers corresponding to tasks or access tokens generated for a particular resource in data storage unit 330. Thus, when administrator 320 receives notification that a resource is available, administrator 320 is preferably able to update the access token status by directing database 330 to store the IP address of the resource responsible for the task using the access token's unique identifier.

Upon receiving notification from a resource that a task has been completed, administrator 320 may respond by terminating the access token. Additionally, the resource may respond with the results of the search to administrator 320 via network 340. Upon receiving the results of the task, administrator 320 preferably directs database 330 to update the status of the access token in database 330.

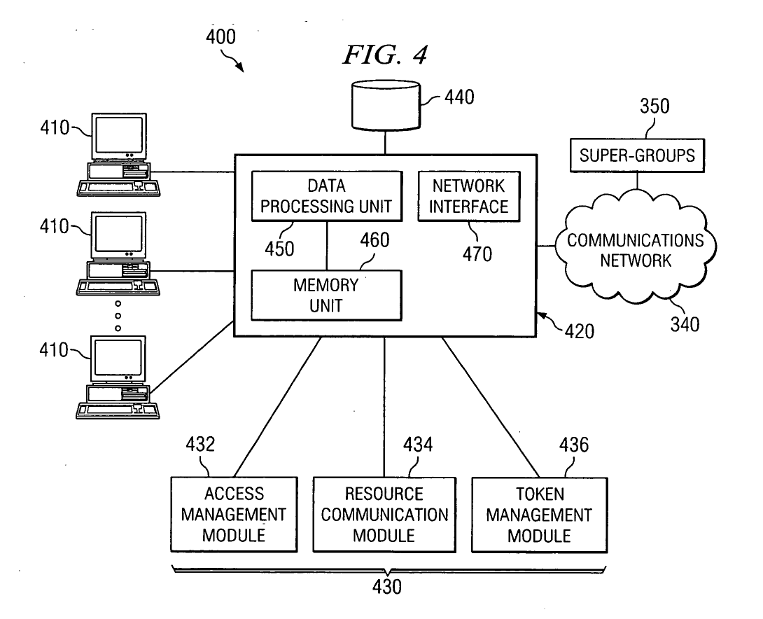

FIG. 4 illustrates a system 400 for providing a directory secured user account. Clients 410 may be coupled to an administrator 420. System 400 may include components of an organization having one or more operator terminals or clients 410, an administrator 420, one or more function modules 430, a database 440, and super-groups 350. An organization's network structure may have components not explicitly illustrated in FIG. 4. The various components may be located at a single site or, alternatively, at a number of different sites. The components of system 400 may be coupled to each other using one or more links, each of which may include one or more computer buses, local area networks (LANs), metropolitan area networks (MANs), wide area networks (WANs), portions of the Internet or any other appropriate wireline, optical, wireless, or other links allowing users, terminals, or clients, to communicate over a network 340. A client 410 may provide an operator access to administrator 420 to configure, manage, or otherwise interact with administrator 420. An operator terminal 410 may include a computer system (which may include one or more suitable input devices, output devices, processors and associated memory, mass storage media, communication interfaces, and other suitable components) or other suitable device.

Administrator 420 may manage data associated with the organization's business or other activities, which may in particular embodiments include creating, modifying, and deleting data files associated with the organization's operations or in response to data received from one or more clients 410, function modules 430, or super-groups 350. Additionally, administrator 420 may call one or more function modules 430 to provide particular functionality according to particular needs, as described more fully below. Administrator 420 may include a data processing unit 450, a memory unit 460, a network interface 470, and any other suitable components for managing data associated with organizational needs. The components of administrator 420 may be supported by one or more computer systems at one or more sites.

One or more components of administrator 420 may be separate from other components of administrator 420, and one or more suitable components of administrator 420 may, where appropriate, be incorporated into one or more other suitable components of administrator 420. Data processing unit 450 may process data associated with organizational business, which may include executing coded instructions (which may in particular embodiments be associated with one or more function modules 430).

Memory unit 460 may be coupled to data processing unit 450 and may include one more suitable memory devices, such as one or more random access memories (RAMs), read-only memories (ROMs), dynamic random access memories (DRAMs), fast cycle RAMs (FCRAMs), static RAMs (SRAMs), field-programmable gate arrays (FPGAs), erasable programmable read-only memories (EPROMs), electronically erasable programmable read-only memories (EEPROMs), microcontrollers, or microprocessors. Network interface 470 may provide an interface between administrator 420 and communications network 340 such that administrator 420 may communicate with super-groups 350, their associated server groups and clients 310, as well as any other system coupled to network 340.

A function module 430 may provide particular functionality associated with handling organizational data or handling data transactions according to system 400. As an example only, and not by way of limitation, a function module 430 may provide functionality associated with search or task management, client communication, data management, billing, account management, or billing management. A function module 430 may be called by administrator 420 (possibly as a result of data received from a client 410, or a client 310 within a super-group 350 as disclosed by FIG. 3, or any other component coupled to communications network 340) and, in response, provide the particular functionality associated with function module 430. A function module 430 may then communicate one or more results to data processing unit 450 or one or more other suitable components of administrator 420, which may use the communicated results to create, modify, or delete one or more data files associated with one or more processors, provide data to an operator at operator terminal 410 or super-groups 350, or perform any other suitable task. Function modules 430 may be physically distributed such that each function module 430, or multiple instances of each function module 430, may be located in a different physical location geographically remote from each other and/or from administrator 420.

In the embodiment shown in FIG. 4, function modules 430 include an access management module 432, a resource communication module 434, and a token management module 436. According to one embodiment of system 400, access management module 432 is preferably operable to generate an access level for a task to be performed within a network architecture such as that illustrated by FIG. 3. The access level generated by access management module 432 may be automatically determined based on the task criteria, may be entered by a user at a client 410, selected from criteria previously stored in database 440, or any other suitable source for generating the access level.

The access level may include any number of individual criteria and/or criteria designed to allow a client coupled to administrator 420 via network 340 to access the system architecture illustrated by FIG. 3 to locate a file, type of file, group of files, or any other data resident in the system, or to perform processing functions associated with the task. For example, the access level generated by access management module 432 may provide for access to a portion of the network to be searched for a specific type of file, file group or folder. Alternatively, the access level generated by access management module 432 may provide for access to data in portions of the system architecture that allows an application to perform functions associated with that application.

Resource communication module 434 preferably communicates the access level to an available resource within the network. The available resource may be a client 410, a client 310 located within super-group 350, or a server located in a super-group 350 or sub-group 354 as described by FIG. 3. Various suitable methods exist for locating a resource within the system to perform an assigned task. In one embodiment, the resource may be located by the resource being idle for a predetermined period of time. The predetermined period of time may be defined by the length of time the client is idle and may notify administrator 420 by sending its Internet protocol (IP) address when the client 310 automatically goes into a screensaver mode.

In an alternative embodiment, when a client 310 or a client 410 has been idle for a specific period of time a server within super-group 350 may identify the idle client within the super-group 350 as being a resource operable to perform a task using a specific application. Resource communication module 434 may also be operable to receive communications from a resource via network 340 to update the status of the access token or the task associated therewith.

The status of access tokens generated by access management module 432 preferably is managed by token management module 436 and stored in database 440. After access management module 432 has generated an access level for transmission to an available resource, token management module 436 may operate to direct administrator 420 to store the search criteria in database 440. Additionally, database 440 may be operable to store the status of any individual access token by a unique identifier assigned to the access token generated by access management module 432. Token management module 436 is preferably operable to store access token status in database 440 by labeling them as active or revoked, or by any other status identifier that allows the status of an access token to be readily ascertained.

For example, once an access token has been generated by access management module 432, token management 436 may direct administrator 420 to store the status of the access token as having been assigned to an available resource. Once resource communication module 434 has established communication with an individual resource and delivered the access token, token management module 436 preferably directs administrator 420 to update the status of the search in database 440 as active. If for some reason, the resource performing the search becomes engaged by a user, the search may be suspended. In such a case, data management module 436 preferably directs administrator 420 to direct database 440 to update the status of the search.

Upon completion of a task, or in the case of a time-dependent access token, that the allowed time has elapsed, the resource using the access token preferably transmits the results of the task via communications network 340 to administrator 420. Alternatively, the access token may be configured to expire during a suspended search after a specified period of inactivity by the resource. Additionally, a resource may transmit a resource status to administrator 420, informing administrator 420, and specifically resource communication module 434, whether or not the resource completed the task or is available for additional tasks, or whether the client is unavailable.

Upon receiving the task results, access management module 432 preferably cancels the access token and directs token management module 436 to update database 440. Preferably, the status of each access token is stored according to the unique identifier in database 440 so that the status of all access tokens is easily recalled as needed.

Although the present invention has been described in detail, it should be understood that various changes, substitutions, and alterations may be made, without departing from the spirit and scope of the present invention as defined by the claims.

1. A method for providing network access comprising:
identifying an available network resource, the network resource coupled to a network;
providing an access token to the available network resource, the access token operable to allow an application of the available network resource to access a portion of the network;
tracking the status of the access token; and
terminating the access token.

2. The method of claim 1, wherein the available network resource is a computer terminal.

3. The method of claim 1, wherein the available network resource is a server.

4. The method of claim 2, wherein the available network resource is a sub-group server.

5. The method of claim 2, wherein the available network resource is a super-group server.

6. The method of claim 1, wherein the network is an intranet.

7. The method of claim 1, wherein the network is an extranet.

8. The method of claim 1, wherein the network is the Internet.

9. The method of claim 1, wherein providing the access token to the resource comprises providing a user identification and password to the internet protocol address of the resource.

10. The method of claim 1, wherein providing the access token to the resource comprises providing access to the application of the available network resource, the application operable to perform a specified task by an administrator.

11. The method of claim 1, wherein the portion of the network comprises at least a second resource coupled to the network.

12. The method of claim 11, wherein the at least a second resource comprises a super-group.

13. The method of claim 11, wherein the at least a second resource comprises a sub-group.

14. The method of claim 11, wherein the at least a second resource comprises all resources coupled to the network.

15. The method of claim 12, wherein the available network resource is located in the super-group.

16. The method of claim 13, wherein the available network resource is located in the sub-group.

17. The method of claim 1, further comprising providing a task associated with the access token, wherein the completion of the task terminates the access token.

18. The method of claim 17, further comprising storing a task status for the task associated with the access token.

19. The method of claim 1, wherein tracking the status of the access token comprises storing the status of the access token in a database.

20. The method of claim 19, wherein the status of the access token comprises the application using the access token.

21. The method of claim 19, wherein the status of the access token comprises the internet protocol address of the available network resource to which the access token was provided.

22. The method of claim 1, wherein terminating the access token comprises revoking the access provided by the access token.

23. The method of claim 1, further comprising updating the status of the access token after the access token is terminated.

24. The method of claim 1, wherein an available network resource comprises a resource coupled to the network that has unused processing capability.

25. The method of claim 24, wherein the available network resource further comprises a network resource used simultaneously by a user, the user having an access level unrelated to the access token.

26. A directory user secured account system, comprising:
an access token, the access token operable to provide access to at least a portion of a network;
an administrator, the administrator operable to identify at least one available network resource, provide the access token to the at least one available network resource, and store a status corresponding to the access token; and
a database, the database operable to maintain the stored status corresponding to the access token.

27. The system of claim 26, wherein the access token is operable to allow an application resident on the at least one available network resource to access the at least a portion of the network.

28. The system of claim 27, wherein the at least one available network resource is coupled to a super-group, coupled to the administrator via the network.

29. The system of claim 28, wherein the at least one available network resource is coupled to a sub-group, the sub-group coupled to the super-group.

30. The system of claim 28, wherein the at least a portion of the network comprises the super-group.

31. The system of claim 29, wherein the at least a portion of the network comprises the subgroup.

32. The system of claim 27, wherein the access token comprises a unique user identifier, the user identifier operable to track the application's access to the network.

33. The system of claim 26, wherein the administrator comprises an application resident on an administrator, the administrator coupled to the network.

34. The system of claim 33, wherein the database is coupled to the administrator, the administrator further operable to direct the database to maintain the status of the access token.

35. The system of claim 26, wherein the at least one available network resource comprises a terminal coupled to the network, the terminal comprising a processor having available processing capability.

36. The system of claim 26, wherein maintaining the stored status corresponding to the access token comprises storing the access token according to the unique identifier.

37. The system of claim 27, wherein the access token is operable to expire in a pre-determined length of time.

38. The system of claim 27, wherein the access token is operable to expire at the conclusion of a pre-defined event.

39. The system of claim 38, wherein the pre-determined event comprises the completion or a task assigned to the application resident on the at least one available network resource.

40. The system of claim 39, wherein the task comprises a file search on the portion of the network.

41. The system of claim 39, wherein the task comprises processing data stored on the portion of the network.

42. A system for a directory secured user account, comprising:
an access management module operable to generate at least one access token, each of the at least one access tokens comprising a unique identifier;
a resource communication module operable to transmit the at least one access token to a resource coupled to the network; and
a token management module operable to maintain the status of the at least one access token and the resource.

43. The system of claim 42, further comprising a database, the database operable to store the status of the access token and the resource.

44. The system of claim 43, wherein the resource communication module is further operable to receive notification from the resource that the resource has available processing capability.

45. The system of claim 44, wherein the access management module is further operable to define a portion of the network for access through the access token, the portion of the network corresponding to the location of the resource.

46. The system of claim 45, wherein the access management module is further operable to provide the at least one access token automatically upon receipt of notification by the resource communication module.

47. The system of claim 45, wherein the resource communication module is further operable to transmit a task to the resource, wherein the task is specific to a first application resident in the resource, the task capable of performance by the available processing capability.

48. The system of claim 47, wherein the resource is concurrently engaged by a user, the user accessing a second application, the second application accessing processing capability separate from the available processing capability.

49. The system of claim 47, wherein the resource comprises a server, the server coupled to a super-group, the super-group coupled to the resource communication module via the network.

50. The system of claim 47, wherein the resource comprises a server, the server coupled to a sub-group, the sub-group coupled to a super-group via a sub-network, the super-group coupled to the resource communication module via the network.

51. The system of claim 47, wherein the resource comprises a terminal, the terminal coupled to the resource communication module via the network.

52. The system of claim 51, wherein the resource is coupled to a super-group, the super-group coupled to the resource communication module via the network.

53. The system of claim 51, wherein the resource is coupled to a sub-group, the sub-group coupled to a super-group via sub-network, the super-group coupled to the resource communication module via the network.

54. The system of claim 48, wherein the user comprises a human operator, wherein the human operator has an access level unrelated to the access through the access token.

55. The system of claim 48, wherein the user comprises a second resource, wherein the second resource has an access level unrelated to the access through the access token.

56. The system of claim 47, wherein the database is further operable to store the status of the task provided to the resource.
